(19) United States
(12) Patent Application Publication
(10) Pub. No.: US 2005/0235505 A1
(43) Pub. Date: Oct. 27, 2005

(54) Measuring gauge and measuring tool

(76) Inventor: Jerry Joseph, Woodcliff Lake, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 10/830,572

(22) Filed: Apr. 23, 2004

(51) Int. Cl. G01B 3/50

(52) U.S. Cl. 33/501.45

(57) ABSTRACT

A measuring guide and measuring system includes at least one measuring gauge having at least one notch proximate an outer boundary of the gauge. A pair of opposing walls bound each notch and provide an alignment and measurement guide in use. Alternative embodiment include multiple measuring guides pivotally joined in a set allowing an individual guide to be pivoted for use and conveniently stored. Alternative embodiments also include replaceable parts allowing easy adjustability of the guide or the use of the guide members in a kit for convenient storage when not in use.

### BACKGROUND OF THE INVENTION

1. Field of the Invention

The present invention relates to a measuring tool. More specifically, the present invention relates to measuring gauges for use in accurately measuring the outer shape of a rigid member.

2. Description of the Related Art

Conventional measuring gauges have been developed for a broad range of uses, many gauges specific to a selected use. Conventional measuring gauges span the spectrum from high-tech laser reflectometers for measuring flaws in mirror grinding and fiberoptic positioning, to simple mechanical feeler gauges to determine spark plug gap spacings.

Mechanical measuring feeler gauges are adapted to measure gaps between opposing surfaces by employing a positive member to be placed between two members defining a gap-to-measure. Other mechanical gauges are used to determine an outer diameter of a selected work piece. These types of gauges are called negative gauges as they are meant to surround or encompass a portion of the item-to-be-measured, i.e. have a ‘negative-recess’ for receiving the item-to-be-measured.

One example of a negative-type measuring gauge is found, for example, in U.S. Pat. No. 1,638,885 for a Safety Appliance Gauge. This disclosure provides a rigid rectilinear metal sheet with a series of linearly notches inter-spaced with rigid fingers. The inner diameter's of the notches reflects a desired measurement. A user simply determines if a select notch, say notch 3 for example, fits over a hand-hold-to-be-measured and determines if the measurement is within limits. In U.S. Pat. No. 1,638,885, the contents of which are herein incorporated by references, it is important to note that the distance between opposing rigid fingers is slightly less than the diameter of the end notch. For example, a notch diameter may be 10 millimeters (mm), but the opposing rigid fingers guarding the entrance to the notch may have a spaced-apart distance of 9 mm. In this manner, the Safety-Appliance Gauge may operate as a one-sided go-no-go gauge by allowing measurement of a diameters X<10 mm. Gauges which measure only a result of ‘less than or equal to’ are called one-sided gauges because they enable only a single measurement.

Multiple negative-type measuring gauges may be operably joined together for a user's convenience. In U.S. Pat. No. 867,011, for a Tool Or Gage For Machinists, the contents of which are incorporated by reference, a plurality of negative-type gauging members are pivotally joined to opposite ends of two spaced apart sides so that the gauging members nest between the sides when not in use. Conventionally it is also clear that individual gauging members may include, or be closely associated with, markings to show the particular size employed.

Multiple negative-type measuring gauges are formed in many shapes, especially adapted to the particular needs of the end user. For example, U.S. Pat. No. 867,011 is easily foldable for convenience to expose a single gauging member at a time, while protecting the remaining gauging members. Unfortunately, this design does not allow the remaining gauging members to be used except with an additional step of opening a new member and replacing the previously exposed member. U.S. Pat. No. 1,638,885 is designed as a rigid elongated rectangular having a defined length, itself a measurement tool, with a series of negative gauges arrayed along one edge. This design allows a user to quickly try closely related gauge sizes but is not collapsible.

An alternative to this type of elongated design can be seen from U.S. Pat. No. 363,331 for a Combination Tool, the contents of which are incorporated by reference, where one edge of the gauges includes an array of measurement gauges, the opposite edge a ruler, one end is a screw driver and wire cleaner, the opposite end includes a series of wrench openings, and the center includes an array of circular openings to measure wire diameters.

Still another design may be seen in a single circular gauge where a plurality of angular openings, originating from a small circle, extend radially about an outer diameter of the gauge. An example of this can be seen as a bevel-finder gauge where a user inserts, for example, a chisel end, into various openings in an attempt to determine the grind angle at the end of the chisel.

It should be understood, that the plurality of measuring gauges, pivotally attached to a holding body may optionally include alternative gauge shapes for threading. As shown in U.S. Reg. No. 6,047,606 for a Combination Bolt Sizing Tool, the pivotably attached measuring gauges include various thread sizes and bolt diameter sizes.

Another variant of pivotally attached gauges can be found in U.S. Pat. No. 781,960, for a Combined Template and Gauge. In this apparatus, multiple gauges pivot about a central joining point, each containing both a template and a gauge.

Unfortunately, none of the conventional gauges known includes a broad arrangement of circular-type gauges supporting an array of negative-type measurement gauges bounded by opposing parallel sides having the same measurement as an inner radius. Furthermore, none of the conventional gauges allows a thin multi-gauge design easily manufactured from a plastic or non-metallic material, that will sit flat in a user's pant or shirt pocket for easy access after combination. Finally, none of these designs enables both a compact/folding ability while retaining the ability to quickly check associated multiple gauge sizes, for example a size range of 19, 20, 21, 23 mm, without additional finger movements to expose new gauge members.

### OBJECTS AND SUMMARY OF THE INVENTION

It is thus a general object of the present invention is to provide a measurement gauge which overcomes at least one of the detriments noted above in the conventional art.

In carrying out the above object, and other objects, features, and advantages of the present invention a sway bar measuring gauge and tool is provided.

It is another object of the present invention to provide a measurement gauge having a generally cylindraceous design supporting an array of negative-type openings having a smooth cylindraceous bottom radius and extending guiding fingers with opposing parallel sides having the same spaced apart distance as twice the bottom radius.

It is another object of the present invention is to provide a measurement gauge easily manufactured from various materials, including a plastic, a metal, an organic substance such as wood, or a combination thereof.

It is another object of the present invention to provide a measurement gauge easily adapted to both a pivoting hinge and a flip-type (pin-type) hinge to positively fix multiple gauge members together.

The present invention relates to a measuring gauge and measuring tool includes at least one measuring gauge having a plurality of notches and fingers arrayed about an outer perimeter. A pair of walls bound each notch and provide an alignment and measurement guide in use. Multiple measuring guides may be pivotally joined in a set allowing an individual guide to be pivoted away from the set and back together allowing the set of gauges to form a convenient planar unit for storage when not in use.

According to an embodiment of the present invention, there is provided a measurement gauge, comprising: a main body having an outer perimeter, a plurality of notches and fingers alternatingly arrayed about the outer perimeter, a first and a second side wall bounding the notch, a bottom surface in the notch joining the first and second walls, and respective portions of the first and second side walls in the notches being substantially parallel to each other, whereby the measurement gauge increases an accuracy of a measuring action along the side walls.

According to another embodiment of the present invention, there is provided a measurement gauge, wherein: the main body is a cylindraceous main body, the plurality of notches and fingers being axially arrayed about the perimeter, and the bottom surface being a curved surface, whereby the side walls and the bottom surface of the notch are effective as measurement gauge for an item to be measured.

According to another embodiment of the present invention, there is provided a measurement gauge, further comprising: at least one carry opening proximate at least one of a center of the cylindraceous main body and a selected one of the fingers, whereby the carry opening enables a secure linking of the gauge with an external securing element thereby minimizing an unintended separation of the gauge from a gauge user.

According to another embodiment of the present invention, there is provided a measurement gauge tool kit, comprising: at least a first and a second measurement gauge, the measurement gauge defining a plane and having a main body generally bounded by an outer perimeters, a plurality of notches and projecting fingers alternatingly arrayed about a portion of the outer perimeter, a first and a second side wall bounding the notch, a bottom surface in the notch joining the first and the second side walls, and respective portions in the first and the second side walls in the notch being substantially parallel to each other, whereby the measurement gauge increases an accuracy of a measuring action in the notch during a use.

According to another embodiment of the present invention, there is provided a measurement gauge tool kit, further comprising: means for pivotally joining the at least first and the second gauges, whereby the gauges may be pivoted from a use position exposing at least one of the plurality of notches for measurement use to a convenient compact storage position.

According to another embodiment of the present invention, there is provided a measurement gauge tool kit, wherein: the means for pivotally joining enables at least one of a planar pivoting and a dihedral pivoting, whereby the measurement gauges may be conveniently stored as a unit and pivotally selectable for a use.

According to another embodiment of the present invention, there is provided a measurement gauge tool kit, wherein: the means for pivoting is a planar pivoting means, at least one pivot hinge pin in the planar pivoting means, the pivot hinge pin joining planar sides of respective the measurement gauges, and during the use, the planar pivoting means enabling one of the at least two measurement gauges to pivot in a plane substantially parallel to a plane of the other measurement gauge, whereby a user may measure an item to be measured with any one of the notches arrayed about the boundary perimeters.

According to another embodiment of the present invention, there is provided a measurement gauge tool kit, wherein: the means for pivoting is a dihedral pivoting means, the dihedral pivoting means including at least a male and a female projection extending from respective boundary perimeters of selected measurement gauges, at least one pivot hinge pin in the dihedral pivoting means joining the male and female projections, and during the use, the dihedral pivoting means enabling one of the at least two measurement gauges to pivot away from a plane substantially parallel to a plane of the other measurement gauge, whereby a user may measure an item to be measured with any one of the notches arrayed about the boundary perimeters.

According to another embodiment of the present invention, there is provided a measurement gauge tool kit, further comprising: at least a third measurement gauge, the third measurement gauge defining a plane and having a third main body generally bounded by a third boundary perimeter, and means for pivotally joining ones of the at least first, second, and third gauges, whereby the gauges may be pivoted from a use position exposing at least one of the plurality of notches for measurement use to a convenient compact storage position.

According to another embodiment of the present invention, there is provided a measurement gauge tool kit, wherein: the means for pivotally joining the gauges is least one of a planar pivoting means and a dihedral pivoting means, whereby the at least first, the second, and the third measurement gauge maybe conveniently stored as a planar unit while the measurement gauge remains pivotally selectable for the use.

According to another embodiment of the present invention, there is provided a measurement gauge system, comprising: at least a first gauge body, at least one first notch in an outer surface of the gauge body defining opposing first side walls spaced apart by a first distance and joined by a first bottom surface, at least a first receptacle in the first notch proximate one of the first side walls, and at least one shim member having at least a first thickness and being removably engageable in the at least first receptacle proximate the one of the first side walls, whereby during a use the at least one shim may be optionally engaged in the first receptacle thereby reducing the first distance by the first thickness and enabling the gauge system to gauge at least two distances within the one first notch.

According to another embodiment of the present invention, there is provided a measurement gauge system, further comprising: at least a second notch in an outer surface of the gauge body defining second opposing side walls spaced apart by a second distance and joined by a second bottom surface, at least a second receptacle in the second notch proximate one of the second side walls, and at least a second shim member having at least a second thickness and being removably engageable in the at least second receptacle, whereby during the use the at least second shim may be optionally engaged in the second receptacle thereby reducing the second distance by the second thickness and enabling the gauge system to gauge at least one additional distance within the second notch.

According to another embodiment of the present invention, there is provided a measurement gauge system, further comprising: at least a second gauge body, at least one second notch in an outer surface of the second gauge body defining second opposing side walls spaced apart by a second distance and joined by a second bottom surface, at least a second receptacle in the second notch proximate one of the second side walls, and at least a second shim member having at least a second thickness and being removably engageable in the at least second receptacle proximate the one of the second side walls, whereby during the use the at least second may be optionally engaged in the second receptacle thereby reducing the second distance by the second thickness and enabling the gauge system to gauge at least two distances within the second notch.

According to another embodiment of the present invention, there is provided a measurement gauge system, further comprising: means for pivotally joining the at least first and the second gauges, whereby the gauges may be pivoted from a use position exposing at least one of the notches for a measurement use to a convenient compact storage position.

According to another embodiment of the present invention, there is provided a measurement gauge system, wherein: the means for pivotally joining enables at least one of a planar pivoting and a dihedral pivoting, whereby the measurement gauges may be conveniently stored as a unit and pivotally selectable for the use.

According to another embodiment of the present invention, there is provided a measurement gauge system, wherein: the means for pivoting is a planar pivoting means, at least one pivot hinge pin in the planar pivoting means, the pivot hinge pin joining planar sides of respective the measurement gauges, and during the use, the planar pivoting means enabling one of the at least two measurement gauges to pivot in a plane substantially parallel to a plane of the other measurement gauge, whereby a user may measure an item to be measured with any one of the notches arrayed about the boundary perimeters.

According to another embodiment of the present invention, there is provided a measurement gauge system, wherein: the means for pivoting is a dihedral pivoting means, the dihedral pivoting means including at least a male and a female projection extending from respective boundary perimeters of selected measurement gauges, at least one pivot hinge pin in the dihedral pivoting means joining the male and female projections, and during the use, the dihedral pivoting means enabling one of the at least two measurement gauges to pivot away from a plane substantially parallel to a plane of the other measurement gauge, whereby a user may measure an item to be measured with any one of the notches arrayed about the boundary perimeters.

According to another embodiment of the present invention, there is provided a measuring gauge tool system, comprising: at least one gauge body, at least a first female opening defined in an outer boundary of the gauge body, at least a first male insert replaceably insertable in at least the first female opening during a use, the at least first male insert including at least one notch having a first size, a first set of opposing side wall bounding the one notch and joined by a bottom surface, and respective portions of the first set of side walls being substantially parallel to each other, whereby the tool system employing the first male insert increases an accuracy of a measuring action along the first set of side walls.

According to another embodiment of the present invention, there is provided a measuring gauge tool system, further comprising: at least a second male insert replaceably insertable in the at least first female opening during the use, the at least second male insert including at least a second notch having a second size, a second set of opposing side walls bounding the second notch and joined by a second bottom surface, and respective portions of the second set of side walls being substantially parallel to each other, whereby the tool system employing the second male insert increases the measuring action along the second set of side walls.

According to another embodiment of the present invention, there is provided a measuring gauge tool system, further comprising: at least a second gauge body, at least a second female opening defined in an outer boundary of the second gauge body, at least a second male insert replaceably insertable in at least the second female opening during the use, the at least second male insert including at least one notch having a second size, a second set of opposing side wall bounding the second notch and joined by a second bottom surface, respective portions of the second set of side walls being substantially parallel to each other, whereby the tool system employing the second male insert increases an accuracy of a measuring action along the second set of side walls, and means for pivotably engaging the at least first and the second gauge bodies, whereby the gauges may be pivoted from a use position exposing at least one of the female openings and the notches for a measurement use to a convenient compact storage position.

According to another embodiment of the present invention, there is provided a measuring gauge tool system, wherein: the means for pivotally engaging enables at least one of a planar pivoting and a dihedral pivoting, whereby the measurement gauges may be conveniently stored as a unit and pivotally selectable for a use.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a top view of measuring guide members, according to one embodiment of the present invention.

FIG. 2 is a top view of another embodiment of the present invention joining multiple measurement gauges at pivot points.

FIG. 3A is a top view of the present embodiment pivoted together for storage while allowing multiple use.

FIG. 3B is a sectional view through line I-I of FIG. 3A.

FIG. 4 is a top view of measuring guide members, according to another embodiment of the present invention employing an alternative joining system.

FIG. 5 is a top view of the embodiment from FIG. 4.

FIG. 6 is a partial side view from plane II-II of FIG. 5.

FIG. 7 is a partial exploded view along plane II-II of FIG. 5.

FIG. 8 is a plain view of another alternative embodiment of the present invention.

FIG. 9 is a close-up partial view of the embodiment shown in FIG. 8.

FIG. 10 is a plane view of another alterative embodiment of the present invention.

FIG. 11 is a partial exploded view of the alternative embodiment shown in FIG. 10.

### DETAILED DESCRIPTION OF THE PREFERRED EMBODIMENTS

In the automotive industry, particularly the automotive repair industry, accurate measurement during automotive repair is essential to ensure long life and safe use of new and replacement parts. Many automotive repairs are conducted in sub-optimal conditions, at awkward angles, or in hot, dirty, or wet conditions unsuitable to careful and deliberate measuring with known measuring devices i.e. a caliper or other singular measurement device. Such complex variable measurement devices often require additional training to use, for example to estimate sizes thousandths of inches from a circular caliper display.

While the automotive industry is an illustrative example, the teachings of present invention should be understood as easily useable in, and transferrable to, other mechanical, electronic, or chemical industries and practices where accurate measurement is essential.

As an example, where an operator is untrained, incompletely trained, or when environmental conditions (dark/hot/cold/wet) make it difficult to correctly operate a variable measurement device (caliper) it is envisioned that a new form of measurement gauge or go-no-go gauge is needed to enable rapid determination of a size, here illustrated as a correct size bushing and sway bar for an automobile. It is envisioned that the present device provides both a negative-type gauge and a go-no-go gauge depending upon the use.

The present invention relates to measuring a particular cylindraceous automotive element called a sway bar, but it is envisioned that the present invention may be readily adapted to measuring multiple cylindraceous elements. Sway bars are part of the general under-car package and are used to transfer forces from one side of a vehicle to another side in a well known manner. Sway bars are typically used in various ways more fully discussed in U.S. patent application Ser. No. 10/420,051 for “Sway Bar Bushing” by the present inventor, the contents of which are herein incorporated by reference.

Sway bars are typically held in place by a rigid metal bracket secured to a rigid frame member. A sway bar bushing typically surrounds the sway bar and tightly fills the sway bar brackets and elastomerically secures the sway bar. This bushing allows the sway bar to shift and twist slightly during movement, while still tightly retaining the bar in the bracket and eliminating slippage.

Sway bar bushings are typically made from an elastomeric type of material which eventually breaks down, becomes embrittled, and otherwise losses effectiveness over time, requiring replacement. Since a sway bar bushing must tightly fit about the cylindraceous sway bar, even small differences in size between the outer surface of the sway bar and the inner surface of the bushing diminishes both the effectiveness and life-span of the bushing. Where bushings are too small they cannot completely surround the sway bar and prevent moisture and debris entry. Where bushings are too large, they cannot properly secure the sway bar causing the same problem. Consequently, an error in measurement, even a millimeter or two of difference, may detrimentally effect the sway bar-bushing to bracket fit.

Since sway bars from various international and domestic suppliers have different diameters, and since vehicle assembly and repair is always a time critical environment, it is important to both quickly and accurately measure the sway bar to determine which size bushing to replace despite the impediments mentioned above (dark/cold etc.).

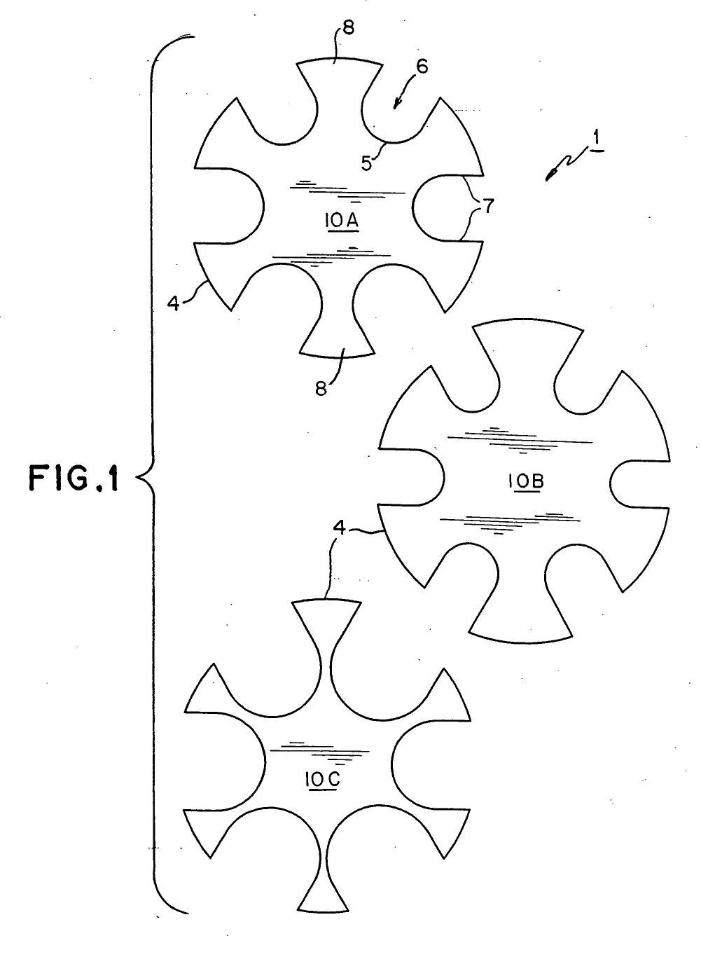

Referring now to FIG. 1, a first embodiment of a measuring gauge tool 1 includes a plurality of individual measuring gauges, or measuring gauge tools. The present embodiment includes a total of three individual measuring gauges, a small size gauge 10A, a middle size gauge 10B, and a large size gauge 10C, but the number of individual gauges may be increased or decreased depending upon a manufacturer's desire. It is specifically noted that measuring gauge tool 1 may include a single measuring having selectively sized openings. One of the preferred embodiments of the present invention includes three measuring gauges, as shown.

Each gauge 10A, 10B, and 10C includes a plurality of notches 6 and fingers 8 alternatingly spaced about a defined outer boundary or perimeter 4. As shown each gauge is conveniently shown as a generally cylindraceous body having outer boundary or perimeter 4 shaped such that notches 6 and fingers 8 are spaced radially about a common center point. Those skilled in the art will understand that the descriptive cylindraceous phrase refers to an object having a generally curved shape, including oval, oblong, cylindrical, and rounded shapes, being circular is not required.

Opposing parallel walls 7 bound each notch 6 and continuously extend into a bottom surface 5. Bottom surface 5 has a generally arcuate shape capable of matching the outer surface of a cylindraceous item-to be gauged, for example a sway bar.

In the present embodiment it is envisioned that the device will be used to measure the outer diameter of a cylindrical sway bar bushing, but other embodiments may be adapted for use with alternatively shaped items-to-be-measured having elliptical or oval shapes.

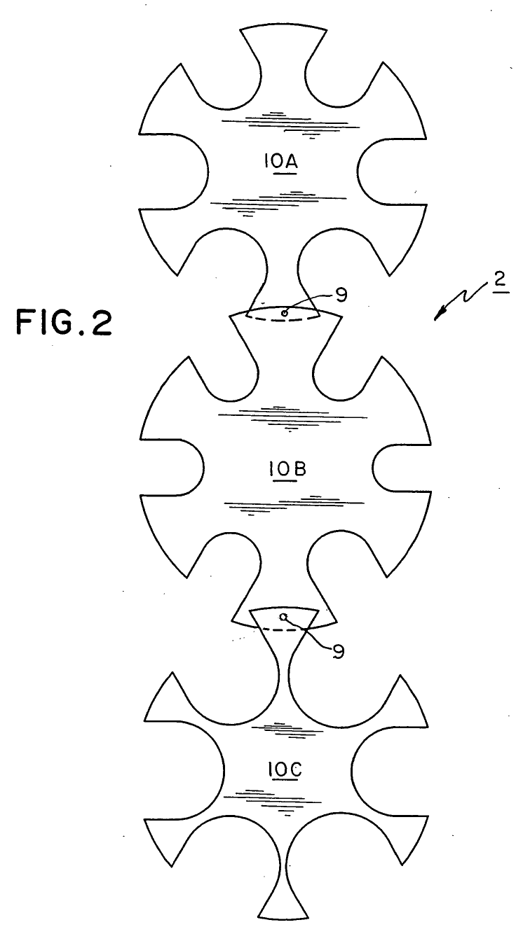

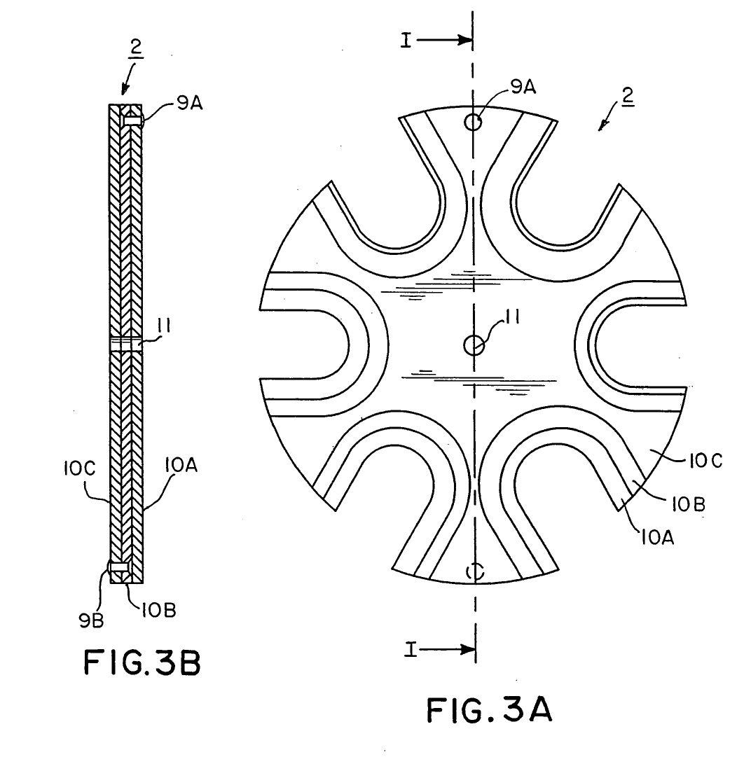

Referring now to FIGS. 2, 3A, and 3B, individual gauges 10A, 10B, and 10C are co-joined forming a measuring gauge tool 2. The individual measuring gauges 10A, 10B, 10C are pivotably joined proximate respective outer boundaries 4 at respective pivot hinges 9, 9 as shown, to form alternative measuring guide tool embodiment 2. Pivot hinges 9, 9 have respective pivot pins 9A, 9B as shown. It should be understood, that pivot hinges 9, 9 are a pivot hinge means readily adapted to a wide range of types of pivot hinge and style of hinge (e.g. barrel hinge, ball-hinge etc.). The present embodiment shown is a form of “planar pivot,” as defined herein. Planar pivots exist wherein each individual gauge's generally flat surface plane pivots along a direction generally parallel relative to the surface planes of the other individual gauge(s) (via hinges 9). It should be further understood, that the various measuring gauge sizes 10A, 10B, 10C may be employed in various orders, from small to largest or, medium-small-large, etc. One preferred embodiment is shown in FIG. 2, with a small to large arrangement, allowing the additional benefit of immediate use-access to the notches in the smallest gauge. Respective pivot pins 9A, 9B join successive individual gauges to form measuring gauge tool 2.

Additional individual gauges (more than three) may be joined to measuring gauge tool 2, where pivot hinges 9 are used to join adjacent layers in an alternating manner forming planar units, as shown in FIG. 3B. In this manner, a wide range of sizes may be conveniently stored and pivotally available for measurement use.

In use, a single individual gauge, or an entire section of individual gauges may be rotated relative to the others to allow clear gauging access to individual notches 6 or a series of selected notches 6 around the outer perimeter of gauge tool 2. When compacted, the individual gauges have aligned centers holes 11.

Center holes 11 provide a convenient carry opening for a user to place a string or other device to prevent losing the gauge in use. In use, it should be understood by those skilled in the art, that while an individual gauge, for example measuring gauge 10C is pivoted away from the remaining gauges 10A and 10B, a user can quickly check the measurement of a sway bar or other object believed to be within the size range on gauge 10C, and if the user is incorrect, the user can immediately attempt to check the size range in gauge 10A. This design creates a convenient layered ability (see FIG. 3A) enabling the smallest size gauge 10A to remain constantly available for use without having to pivot the remaining gauges 10B, 10C out of the way.

For convenience in a particular industry, smallest size gauge 10A may be constructed to match the most common measurement sizes, providing further convenience in use. In this manner, measuring guide tool 2 is both a negative-type gauge and provides a ranging gauge allowing determination of sizes bounding either side of a selected measurement, for example 29 mm≦X≦30 mm.

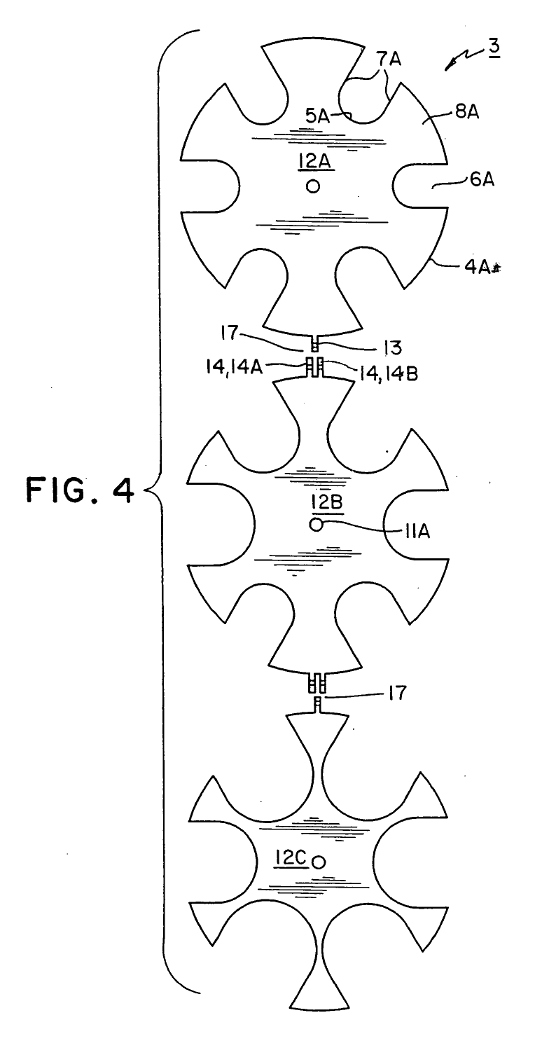

Referring now to FIGS. 4 to 7, another embodiment of a measuring gauge tool 3 includes a series of small, medium, and large size measurement gauges 12A, 12B, and 12C as shown.

Each gauge 12A, 12B, and 12C includes a plurality of notches 6A and fingers 8A alternatingly spaced about an outer boundary 4A. As shown, each gauge is conveniently shown as a generally cylindraceous body having outer boundary 4A shaped such that notches 6A and fingers 8A are spaced radially about a common center point or central hole 11A. Those skilled in the art will understand that the descriptive cylindraceous phrase refers to an object having a generally curved shape, including oval, oblong, cylindrical, and rounded shapes, being circular is not required.

Opposing parallel walls 7A bound each notch 6A and continuously extend into a bottom surface 5A. Bottom surface 5A has a generally arcuate shape capable of matching the outer surface of a cylindraceous item-to be gauged, for example a sway bar.

In the present embodiment it is envisioned that the device will be used to measure the outer diameter of a cylindrical sway bar bushing, but other embodiments may be adapted for use with alternatively shaped items-to-be-measured having elliptical or oval shapes.

A barrel-type pivot hinge 17 joins respective measurement gauges and includes a male side 17A projection and a female side 17B projection pivotally joined by a pivot pin 15. Male side 17A projection includes a projecting tongue 13 with an axial hole projecting away from outer surface or outer boundary 4A. Female side 17B projection includes a pair of projecting bumps 16A, 16B, on a set of extensions 14A, 14B. Each projecting bump 16A, 16B includes a coaxial central hole for pivotally receiving pivot pin 15. When sides 17A, 17B are aligned coaxially, pivot pin 15 is inserted and secured to prevent accidental removal and form an alternative pivoting means.

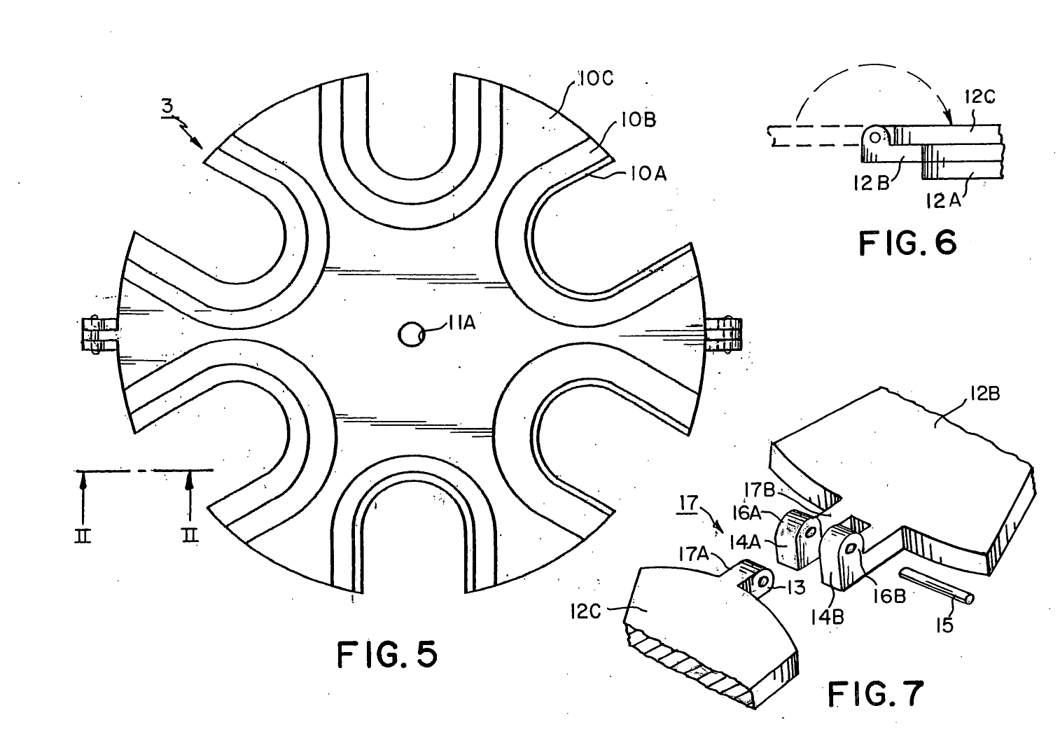

In this manner, measurement gauges 12A, 12B, and 12C are pivotally joined and may be folded into a flat and compact stack as seen in FIG. 5., suitable for placing in a mechanic's pocket for use under a vehicle. It should be understood that, as shown, the present embodiment provides a “dihedral pivot” or means for dihedral pivoting where the dihedral (between to planes) pivot means allows the planes of each measurement gauge to pivot away from the planes of the other gauges. Alternative types of hinge means have been mentioned (e.g. ball-type hinges) and may be readily adapted to the instant invention. Alternatively, multiple gauges may be removably connected by a magnetic member positioned within each individual gauge. A magnetic member, for example, may be positioned in the center of each individual gauge 12A, 12B, 12C and allow the magnetic attraction therebetween. While a magnetic attachment does not operate in a truly ‘pivot hinge’ manner, it is an intention of the present description to include ‘magnetic attachment’ as one of the ‘pivot hinge’ means described herein, allowing a common reference to pivot hinge to include magnetic attachment mechanisms.

As previously discussed, when measurement gauges 12A, 12B, and 12C are assembled into measuring gauge tool 3 the smaller gauge 12A may be used without unfolding as the notches 6A are already exposed. In the present embodiment, the dihedral pivot hinges allow the measurement gauges to be stored as a planar unit for positioning in a user's pocket, where each individual gauge is protected by the mass of the entire planar unit. i.e. gauges stored aligned in parallel planes.

As noted above, the phrase cylindraceous or generally cylindraceous as used herein refers to a object's outer surface shape having a curved or an arc (i.e. portion) of an outer surface following a generally circular, oblong, oval, elliptical, regular or irregular curved generally relating to a circle.

It should be additionally understood, that the bottom radius of each gauging member is a generally arcuate shape, or shaped following an arc (portion) of a cylindraceous shape, whose key importance is being able to measure the outer diameter of a vehicle sway bar or other cylindrical mechanical member to be measured.

It is should also be understood that the various notches and fingers arrayed about the outer periphery of the measuring gauge may be selected at various sizes, for example, where six (6) notches are present, their sizes may, for example be 23, 24, 25, 26, 27, and 28 millimeters (mm). In another example, as shown in one preferred embodiment, where a set of three measuring gauges is joined, the resultant measuring gauge tool has three times six notches and may therefore span a broad range of sizes, for example from 17 mm to 36 mm.

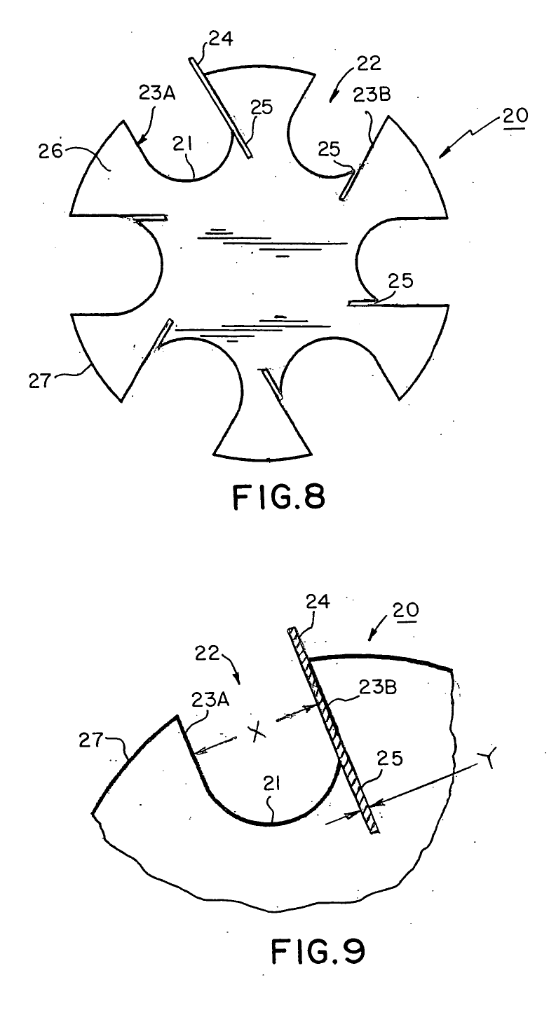

Referring now to FIGS. 8 and 9, an alternative embodiment of the present invention includes one measure gauge 20 including a plurality of notches 22 and fingers 26 alternatingly positioned about an outer periphery. Each notch 22 includes opposing walls 23 joined by a bottom surface 21. Walls 23 include a continuous wall 23A arising smoothly from bottom surface 21 and a slotted wall 23B, as shown.

In the present embodiment, a receptacle 25 is defined along slotted wall 23B and is shaped to receive a shim 24. Shim 24 is optionally positioned within receptacle 25 as will be described. When in position, shim 24 projects beyond the outer periphery of gauge 20 enabling a user to easily grasp and insert/remove shim 24 as needed.

Either one or both of receptacle 25 and shim 24 may optionally include a means for securing shim 24 within receptacle. For example, a spring detent, ball catch, or other mechanism may be used to prevent unintended removal of shim 24 from receptacle 25. Alternatively, shim 24 and receptacle 25 may be formed in a manner closely matching their sizes and retaining relative positions through friction forces alone. In any case, those skilled in the art of mechanical gauge design will recognize that many means exist for securely engaging shim 25 within receptacle 25 and minimizing an unintended removal therefrom.

As shown, notch 22 defines a distance between walls 23 (23A, 23B) as the sum of X+Y. The width of shim 24 is defined as Y, such that the difference between continuous wall 23A and the outer surface of shim 24 is the distance X.

One feature of the present embodiment, is that a user may employ shims 24 in various receptacles to switch between metric measurements (in millimeters) and standard measurements (in inches), or between close sizes in either measurement system.

For example, in this alternative design of the present, a notch 22 may be shaped as 25 mm (distance X+Y), and a shim 24 may be shaped as 2.04 mm (distance Y), and after engagement between receptacle 25 and shim 24, distance X may be 22.96 mm (or 0.9375 or 15/16 inches). Thus, a user may first check a sway bar believed to be 15/16 and find a loose fit without the shim (25 mm), and then verify the measurement by inserting a selected size shim 24 and reducing the gap to secure an accurate measurement. In this way, for example, the same notch/shim combination may be used to switch between a wide range of metric and standard dimensions common in the automotive or other industry.

In the embodiment shown, notches 22/receptacles 25 are selected from a common space (e.g. 2 mm), but each notch 22/receptacle 25 pair may be matched to specific close metric/standard measurement such that shims 24 are of varying thicknesses depending upon the desired X/Y measurement desired.

Additionally, within the same measurement system, the notch/shim combination may be used interchangeably where receptacles 25 are all of the same width Y, but only a bottom portion of shim 24 is shaped in width Y.

In this manner, the top portion of a shim 24 may be a different width (not shown) that is thicker or thinner than width Y. In this way, a single notch 22 may be used to measure a wide variety of widths with an array of shims 24. For example, a particular notch may be 1.25 inches wide (distance X+Y). A first shim 24 may be 0.4 mm wide (distance Y) reducing the gap to 30 mm a common automotive measurement. A second shim (not shown) may include a bottom portion of 0.4 mm thick (engaging receptacle 25), but have a top portion along slotted wall 23B having a thickness of, say 3.04 mm (note 30.6 mm=1.25 inches reduced to 27.56 mm or 1⅛ inches). In this manner, a gauge may include a single notch 22 with a single receptacle 25 and a plurality of shims 24 (for example joined to a key ring) covering a range of widths and improving a user's convenience.

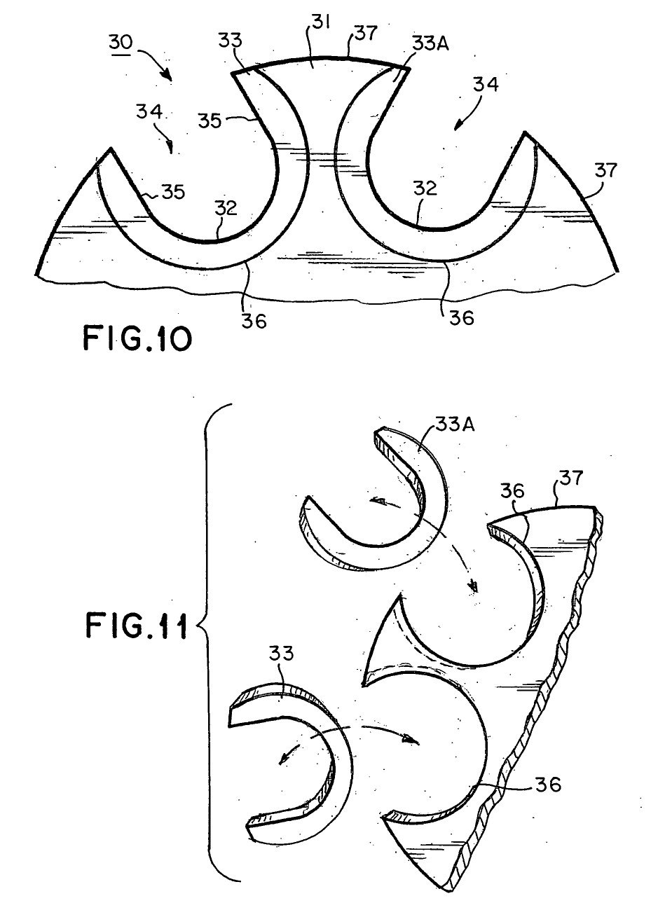

Referring now to FIGS. 10 and 11, another alternative embodiment is shown for a gauge 30 including at least one female opening 36 (female part), formed on an outer boundary 37 of gauge 30. Female opening 36 interchangeably receives a replacement part 33 (male part). Replacement part 33 includes a notch 34 defined by opposing parallel walls 35 joined by a curved bottom surface 32.

Where two or more female openings 36 exist, a finger 31 projects between them and aids in defining the shape of female opening 36 as shown.

An alternative replacement part 33A is additionally shown in an alternative embodiment including at least two female openings 36.

A snug fit, snap engagement, keyed engagement, or other joining mechanism or means exists between female opening 36 and replacement part 33 allowing a user to secure replacement part 33 in female opening 36.

In this embodiment, female opening(s) are shaped having a generally uniform size and generally semi-circular. Replacement parts 33, 33A and others are formed with an outer shape matching the inner semi-circular shape of female openings 36. Employing the joining mechanism enables a user to optionally position multiple replacement parts with female opening 36 as needed.

In one example of this embodiment, female opening 36 may be shaped having a generally 50 mm diameter and a replacement part 33 is positioned therein having a notch 34 with a 20 mm opening or a 0.75 inch opening.

As noted above, a single gauge 30 may be provided in a kit with a plurality of optionally sized replacement parts 34 enabling a user to quickly measure a wide range of sizes. The plurality of replacement parts 34 may be optionally joined in a carrying case (similar to shims 24.

In each of the embodiments noted above, a single member gauge may be provides, or two or more gauges may be joined into a single gauge (for example, two gauges 20 may be pivotally joined in a set or kit enabling a user to measure a wide range of sizes.

While each embodiment herein employs generally parallel sides walls bounding a notch joined by a curved bottom surface, this should be noted as non-limiting. In alternative embodiments (not shown) the side walls may have a curved, angular, or other shape according to a manufacturer's desire or adaptation to a particular need. The present embodiments employ parallel side walls to enable an easy use, but the walls may have other shapes consistent with at least one embodiment herein allowing a different use within the measuring arts. For example, gauge 2, incorporating and pivotally joining multiple gauge members may have sloped notches or non-parallel wall notches.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the spirit and scope of this invention as defined in the following claims.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1. A measurement gauge, comprising:
a main body having an outer perimeter;
a plurality of notches and fingers alternatingly arrayed about said outer perimeter;
a first and a second side wall bounding each said notch;
a bottom surface in each said notch joining said first and second walls; and
respective portions of said first and second side walls in said notches being substantially parallel to each other, whereby said measurement gauge increases an accuracy of a measuring action along said side walls.

2. A measurement gauge, according to claim 1, wherein:
said main body is a cylindraceous main body;
said plurality of notches and fingers being axially arrayed about said perimeter; and
said bottom surface being a curved surface, whereby said side walls and said bottom surface of each said notch are effective as measurement gauge for an item to be measured.

3. A measurement gauge, according to claim 2, further comprising:
at least one carry opening proximate at least one of a center of said cylindraceous main body and a selected one of said fingers, whereby said carry opening enables a secure linking of said gauge with an external securing element thereby minimizing an unintended separation of said gauge from a gauge user.

4. A measurement gauge tool kit, comprising:
at least a first and a second measurement gauge;
each said measurement gauge defining a plane and having a main body generally bounded by an outer perimeters;
a plurality of notches and projecting fingers alternatingly arrayed about a portion of each said outer perimeter;
a first and a second side wall bounding each said notch;
a bottom surface in each said notch joining said first and said second side walls; and
respective portions in said first and said second side walls in each said notch being substantially parallel to each other, whereby said measurement gauge increases an accuracy of a measuring action in each said notch during a use.

5. A measurement gauge tool kit, according to claim 4, further comprising:
means for pivotally joining said at least first and said second gauges, whereby said gauges may be pivoted from a use position exposing at least one of said plurality of notches for measurement use to a convenient compact storage position.

6. A measurement gauge tool kit, according to claim 5, wherein:
said means for pivotally joining enables at least one of a planar pivoting and a dihedral pivoting, whereby said measurement gauges may be conveniently stored as a unit and pivotally selectable for a use.

7. A measurement gauge tool kit, according to claim 5, wherein:
said means for pivoting is a planar pivoting means;
at least one pivot hinge pin in said planar pivoting means;
said pivot hinge pin joining planar sides of respective said measurement gauges; and
during said use, said planar pivoting means enabling one of said at least two measurement gauges to pivot in a plane substantially parallel to a plane of said other measurement gauge, whereby a user may measure an item to be measured with any one of said notches arrayed about said boundary perimeters.

8. A measurement gauge tool kit, according to claim 5, wherein:
said means for pivoting is a dihedral pivoting means;
said dihedral pivoting means including at least a male and a female projection extending from respective boundary perimeters of selected measurement gauges;
at least one pivot hinge pin in said dihedral pivoting means joining said male and female projections; and
during said use, said dihedral pivoting means enabling one of said at least two measurement gauges to pivot away from a plane substantially parallel to a plane of said other measurement gauge, whereby a user may measure an item to be measured with any one of said notches arrayed about said boundary perimeters.

9. A measurement gauge tool kit, according to claim 4, further comprising:
at least a third measurement gauge;
said third measurement gauge defining a plane and having a third main body generally bounded by a third boundary perimeter; and
means for pivotally joining ones of said at least first, second, and third gauges, whereby said gauges may be pivoted from a use position exposing at least one of said plurality of notches for measurement use to a convenient compact storage position.

10. A measurement gauge tool kit, according to claim 9, wherein:
said means for pivotally joining said gauges is least one of a planar pivoting means and a dihedral pivoting means, whereby said at least first, said second, and said third measurement gauge maybe conveniently stored as a planar unit while each said measurement gauge remains pivotally selectable for said use.

11. A measurement gauge system, comprising:
at least a first gauge body;
at least one first notch in an outer surface of said gauge body defining opposing first side walls spaced apart by a first distance and joined by a first bottom surface;
at least a first receptacle in said first notch proximate one of said first side walls; and
at least one shim member having at least a first thickness and being removably engageable in said at least first receptacle proximate said one of said first side walls, whereby during a use said at least one shim may be optionally engaged in said first receptacle thereby reducing said first distance by said first thickness and enabling said gauge system to gauge at least two distances within said one first notch.

12. A measurement gauge system, according to claim 11, further comprising:
at least a second notch in an outer surface of said gauge body defining second opposing side walls spaced apart by a second distance and joined by a second bottom surface;
at least a second receptacle in said second notch proximate one of said second side walls; and
at least a second shim member having at least a second thickness and being removably engageable in said at least second receptacle, whereby during said use said at least second shim may be optionally engaged in said second receptacle thereby reducing said second distance by said second thickness and enabling said gauge system to gauge at least one additional distance within said second notch.

13. A measurement gauge system, according to claim 11, further comprising:
at least a second gauge body;
at least one second notch in an outer surface of said second gauge body defining second opposing side walls spaced apart by a second distance and joined by a second bottom surface;
at least a second receptacle in said second notch proximate one of said second side walls; and
at least a second shim member having at least a second thickness and being removably engageable in said at least second receptacle proximate said one of said second side walls, whereby during said use said at least second may be optionally engaged in said second receptacle thereby reducing said second distance by said second thickness and enabling said gauge system to gauge at least two distances within said second notch.

14. A measurement gauge system, according to claim 13, further comprising:
means for pivotally joining said at least first and said second gauges, whereby said gauges may be pivoted from a use position exposing at least one of said notches for a measurement use to a convenient compact storage position.

15. A measurement gauge system, according to claim 14, wherein:
said means for pivotally joining enables at least one of a planar pivoting and a dihedral pivoting, whereby said measurement gauges may be conveniently stored as a unit and pivotally selectable for said use.

16. A measurement gauge system, according to claim 15, wherein:
said means for pivoting is a planar pivoting means;
at least one pivot hinge pin in said planar pivoting means;
said pivot hinge pin joining planar sides of respective said measurement gauges; and
during said use, said planar pivoting means enabling one of said at least two measurement gauges to pivot in a plane substantially parallel to a plane of said other measurement gauge, whereby a user may measure an item to be measured with any one of said notches arrayed about said boundary perimeters.

17. A measurement gauge system, according to claim 15, wherein:
said means for pivoting is a dihedral pivoting means;
said dihedral pivoting means including at least a male and a female projection extending from respective boundary perimeters of selected measurement gauges;
at least one pivot hinge pin in said dihedral pivoting means joining said male and female projections; and
during said use, said dihedral pivoting means enabling one of said at least two measurement gauges to pivot away from a plane substantially parallel to a plane of said other measurement gauge, whereby a user may measure an item to be measured with any one of said notches arrayed about said boundary perimeters.

18. A measuring gauge tool system, comprising:
at least one gauge body;
at least a first female opening defined in an outer boundary of said gauge body;
at least a first male insert replaceably insertable in at least said first female opening during a use;
said at least first male insert including at least one notch having a first size;
a first set of opposing side walls bounding said one notch and being joined by a bottom surface; and
respective portions of said first set of side walls being substantially parallel to each other, whereby said tool system employing said first male insert increases an accuracy of a measuring action along said first set of side walls.

19. A measuring gauge tool system, according to claim 18, further comprising:
at least a second male insert replaceably insertable in said at least first female opening during said use;
said at least second male insert including at least a second notch having a second size;
a second set of opposing side walls bounding said second notch and joined by a second bottom surface; and
respective portions of said second set of side walls being substantially parallel to each other, whereby said tool system employing said second male insert increases said measuring action along said second set of side walls.

20. A measuring gauge tool system, according to claim 18, further comprising:
at least a second gauge body;
at least a second female opening defined in an outer boundary of said second gauge body;
at least a second male insert replaceably insertable in at least said second female opening during said use;
said at least second male insert including at least one notch having a second size;
a second set of opposing side wall bounding said second notch and joined by a second bottom surface;
respective portions of said second set of side walls being substantially parallel to each other, whereby said tool system employing said second male insert increases an accuracy of a measuring action along said second set of side walls; and
means for pivotably engaging said at least first and said second gauge bodies, whereby said gauges may be pivoted from a use position exposing at least one of said female openings and said notches for a measurement use to a convenient compact storage position.

21. A measurement gauge tool system, according to claim 20, wherein:
said means for pivotally engaging enables at least one of a planar pivoting and a dihedral pivoting, whereby said measurement gauges may be conveniently stored as a unit and pivotally selectable for a use.
